(19) United States
(12) Patent Application Publication
(10) Pub. No.: US 2002/0054727 A1
(43) Pub. Date: May 9, 2002

(54) Wave guide switch based on electric field control of wave reflection and transmission

(76) Inventor: Qi Wang Song, Fayetteville, NY (US)

Correspondence Address: HANCOCK & ESTABROOK, LLP, 1500 MONY Tower I, PO Box 4976, Syracuse, NY, 13221-4976, US

(21) Appl. No.: 09/956,383

(22) Filed: Sep. 19, 2001

Related U.S. Application Data
(60) Provisional application No. 60/233,485, filed on Sep. 19, 2000.

(51) Int. Cl. G02B 6/35; G02B 6/26

(52) U.S. Cl. 385/16; 385/17; 385/22; 385/45

(57) ABSTRACT

Devices and methods for control of reflection and transmission of an optical wave by selective adjustment of the refractive index of a material through use of an applied electric field. In some devices, an electric field vector E is distributed in the material, where the material interfaces two optical waveguides. Since the refractive index n(E) of the material depends on the magnitude and direction of E, the electric field E can be varied to control n(E), relative to the refractive index of the interfaced waveguides, so as to make the material totally transmitting, totally reflecting, or partially reflecting of light that passes through one of the interfacing waveguides and is incident upon the material. Adjusting n(E) in such a material can also be used for selection of optical wavelengths by diffraction, wavelength selection of optical waves transmitted through mirror electrodes, and deflection of plane waves.

### RELATED APPLICATION

The present invention claims priority to U.S. Provisional Patent Application No. 60/233,485, filed on Sep. 19, 2000, which is entirely incorporated herein by reference.

### BACKGROUND OF THE INVENTION

1. Technical Field

The present invention relates to devices having wave propagation in a waveguide, and more particularly to control of reflection and transmission of the wave by adjustment of the refractive index of the material through selective application of an applied electric field.

2. Related Art

The essential physics of an optical waveguide is illustrated in FIGS. 1 and 2. FIG. 1 depicts a cross-sectional view of an optical medium 1 and an optical medium 2 interfacing at a boundary 3. The optical medium 1 has a refractive index n₁ and the optical medium 2 has a refractive index n₂. A light beam 10 in the optical medium 1 and incident upon the boundary 3, is generally transformed into a transmitted beam 12 into the optical medium 2 and a reflected beam 14 back into the optical medium 1. Given an angle of incidence θ_{I}, the angle of transmission θ_{T} is determined from Snell's law: sin θ_{I}/sin θ_{T} =n₂/n₁. The case of n₂=n₁ represents pure transmission with θ_{T} =θ_{I}, with medium 2 said to be in a “totally transmitting state.” The case of n₂<n₁ sin θ_{I} represents pure reflection, called “total internal reflection,” with the medium 2 said to be in a “totally reflecting state.” FIG. 2 depicts total internal reflection. The case of n₂>n₁ sin θ_{I} such that n₂ ≠n₁ represents partial transmission and partial reflection with the medium 2 said to be in a “partially reflecting state,” as illustrated in FIG. 1.

Modern technology has developed useful devices that take advantage of reflective and transitive properties of optical media. Many such devices are in the field of fiber optics communication technology characterized by a transmission of light through thin optical fibers. FIG. 3 depicts a cross-sectional view of an optical waveguide structure, in accordance with the related art. FIG. 3 shows an optical waveguide encapsulated by a lower cladding and an upper cladding, where the lower cladding is on a semi-conductive substrate such as a silicon substrate. The lower cladding, waveguide, and upper cladding may each include doped silica (i.e., SiO₂). In order for light entering the waveguide to be internally reflected so as to remain within the waveguide with negligible leakage as the light propagates into the waveguide, the lower cladding and upper cladding must have refractive indexes sufficiently lower than the refractive index of the waveguide material. In as much as doping materials and associated doping concentrations affect the refractive index, the dopings of the lower cladding, waveguide, and upper cladding may be adjusted so as to generate the aforementioned refractive index relationships among the lower cladding, waveguide, and upper cladding.

Dense wavelength division multiplexing (“DWDM”) is a technique to pack more information into existing optical cable by simultaneously sending separate signals through the same optical fiber at different wavelengths. In operation, the optical transmission spectrum is divided into a number of mutually exclusive wavelengths, each supporting a single communication channel operating at a desired bit-rate. The coexistence of multiple DWDM channels on a single fiber greatly increases the bandwidth over a single wavelength channel. DWDM has been widely accepted and is able to carry eight (8) or more wavelength channels on a single fiber. Compared with the alternative of adding new fiber, DWDM technology provides an effective way to add capacity.

Optical fiber technology is expanding closer to end-users to meet their broadband multimedia requirements. DWDM improves signal transmission in the metro market by carrying signals in their original digital format rather than converting them into a plurality of electronic formats. Because such conversion requires costly electronics, it can be cheaper to dedicate an optic wavelength for transmission in the original format. However, for consumers to fully reap these and other rewards of DWDM technology, faster, more reliable, and cheaper optical fiber devices need to be developed.

Thus, there is a need for faster, more reliable, and cheaper optical fiber devices.

### SUMMARY OF THE INVENTION

The present invention utilizes traditional optical waveguides, but with electrical-optical (“E-O”) material, preferably in the form of a polymer, at the switching junction in optical switches, switching networks, and related communications devices. By selectively changing the refractive index of the E-O material through controlled generation of an electric field therein, the following characteristics of the switches can be manipulated and controlled: index modulation (phase and amplitude modulation); tunable switching; tunable grating; tunable pulse shaping and wavelength add/drop; tunable interference (filter); beam steering (deflection ); and voltage controlled grating or optical waveguide; and directional coupler.

Use of E-O material (e.g., polymers) in the present invention has the following characteristics and advantages: E-O polymer can undergo larger refractive index changes (about 2 to 3 orders of magnitude) than can non-organic materials such as crystals; E-O polymer has a faster response time (from 10⁻³ to 10⁻⁷ second) than does liquid crystal; use of E-O polymer results in lower fabrication cost than with use of other materials (e.g., liquid crystal and solid state crystal); fabrication with E-O polymer is relatively easy compared to the state of the art; and E-O polymer has a wide range of wavelength transparency, especially in an optical communication wavelength range of 1300 nanometers to 2000 nanometers. In addition, the waveguides may be fabricated from low loss material for light propagation and use of E-O polymer which has high loss occurs only at the switching junctions, thereby providing a highly efficient optical switch. Thus, the present invention provides faster, more reliable, and cheaper devices for use in optical networking and communications.

In accordance with the foregoing, the present invention essentially provides an optical switch, comprising:

a first optical waveguide having an input end, a first output end, and a second output end;

a second optical waveguide interconnected to the first optical waveguide includes an input end and an output end; and

an E-O material dispersed at the optical junction between the first output end of the first waveguide and the input end of the second waveguide. The E-O material has a refractive index that is selectively actuable between fully transmitting and fully reflecting states (or, if desired, a partially reflecting/partially transmitting state) through the controlled generation of an electric field therein. The electric field is generated through placement of a pair of electrodes on opposing sides of the E-O material, wherein the electrodes are held at different voltage levels, thereby creating a voltage differential therebetween. The voltage differential creates an electric field across the E-O material, the magnitude of which can be controlled by the magnitude of the voltage differential, and the direction of which can be controlled through the positioning of the electrodes.

The electro-optical physics of the switch permits various types of switching networks, and related communications devices, to be engineered. For instance, the present invention further contemplates a waveguide-based planar cross switch structure, a N×N comb switch structure, an optical diffraction structure, an optical prism structure, and an optical interference structure, all of which include use of an E-O polymer at the switching junctions between waveguides.

### BRIEF DESCRIPTION OF THE DRAWINGS

The present invention will be further understood and appreciated by reading the following Detailed Description in conjunction with the accompanying drawings, in which:

FIG. 1 depicts a cross-sectional view of light being transmitted and reflected at a boundary between two optical media each having a different index of refraction, in accordance with the related art.

FIG. 2 depicts FIG. 1 under a condition of total internal reflection.

FIG. 3 depicts a cross-sectional view of an optical waveguide structure, in accordance with the related art.

FIG. 4 depicts a top view of an optical switch, in accordance with embodiments of the present invention.

FIG. 5 depicts a top view of a 1×2 optical switch, in accordance with embodiments of the present invention.

FIG. 6 depicts a top view of a waveguide-based planar cross switch structure, in accordance with embodiments of the present invention.

FIG. 7A depicts a top view of a 3×3 comb switch structure, in accordance with embodiments of the present invention.

FIG. 7B depicts a magnified view of a portion of the 3×3 cross switch structure of FIG. 7A, showing a material interfaced between two waveguides.

FIG. 7C depicts a vertically oriented cross-section view of the portion of FIG. 7B, taken along line 7C-7C of FIG. 7B, showing electrodes generating an electric field across the material.

FIG. 7D depicts a vertically oriented cross-section view of the portion of FIG. 7B, taken along line 7D-7D of FIG. 7B, showing electrodes generating an electric field across the material.

FIG. 7E depicts FIG. 7D with a redistribution of polarity on the electrodes.

FIG. 8A depicts a top view of an optical diffraction structure, in accordance with embodiments of the present invention, and FIG. 8B depicts a vertically oriented cross-section view taken along line 8B-8B of FIG. 8A.

FIG. 9 depicts a top view of an optical diffraction structure, in accordance with embodiments of the present invention.

FIGS. 10A, 10B, and 10C respectively depicts a top view, a side view, and a front view of an optical diffraction structure, in accordance with embodiments of the present invention.

FIG. 11 depicts a view of an optical interference structure based on a Fabry-Perot interference filter for wavelength selection, in accordance with embodiments of the present invention.

FIG. 12A depicts a top view of an optical prism structure, in accordance with embodiments of the present invention, and FIG. 12B depicts a front view of the optical prism structure of FIG. 12A.

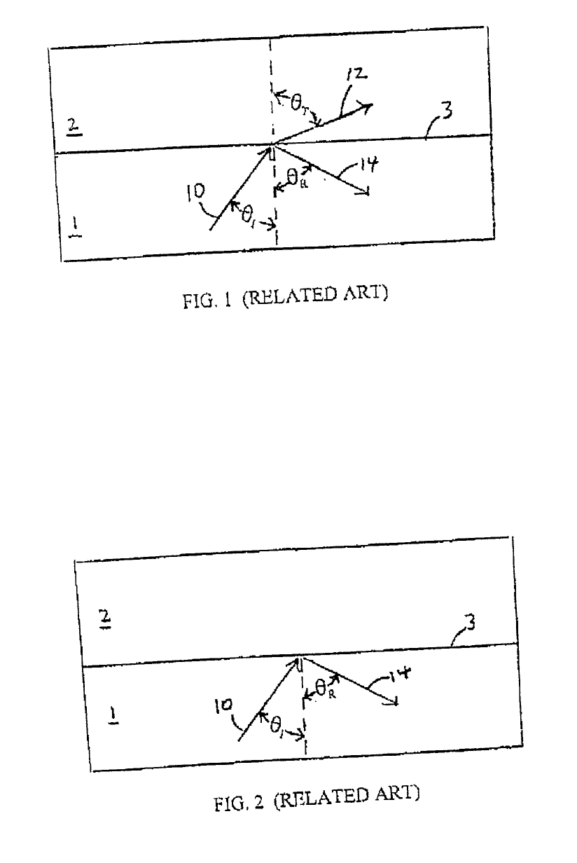

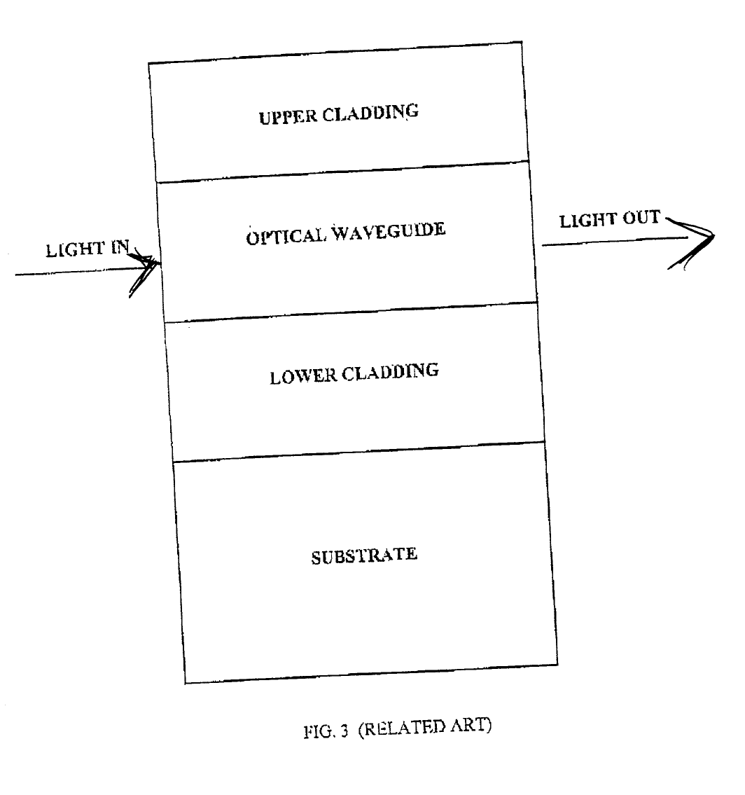

### DETAILED DESCRIPTION OF THE INVENTION

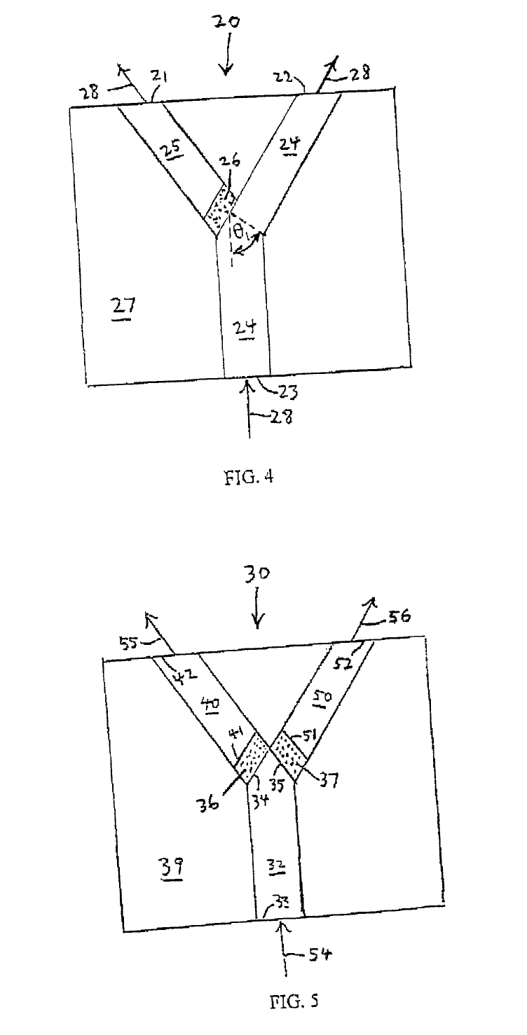

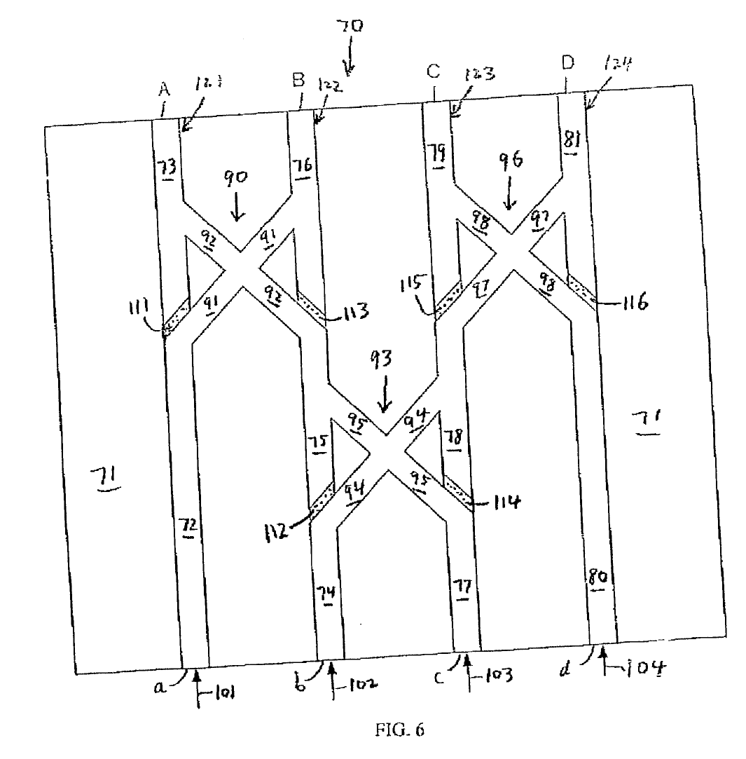

Referring now to the drawings, FIG. 4 depicts an optical switch 20, comprising a substrate 27 on which is disposed an optical waveguide 24, an optical waveguide 25, and a material 26, in accordance with embodiments of the present invention. Upper cladding and lower cladding (not shown) exists above and below each of the optical waveguides 24 and 25 (see FIG. 3 for where the OPTICAL WAVEGUIDE is located relating to the UPPER CLADDING and LOWER CLADDING). The material 26 is interposed between the optical waveguide 24 and the optical waveguide 25 as shown. The optical waveguides 24 and 25 each have about equal refractive indexes.

A beam of light 28 may enter the optical waveguide 24 at an input port 23 of the switch 20. If the material 26 is toggled between a totally transmitting state and a totally reflecting state, then the beam of light 28 will be switched into the optical waveguide 25 so as to exit at output port 21 of the switch 20 when the material 26 is in a totally transmitting state. The beam of light 28 will be reflected to remain in the optical waveguide 24 so as to exit at output port 22 of the switch 20 when the material 26 is in a totally reflecting state.

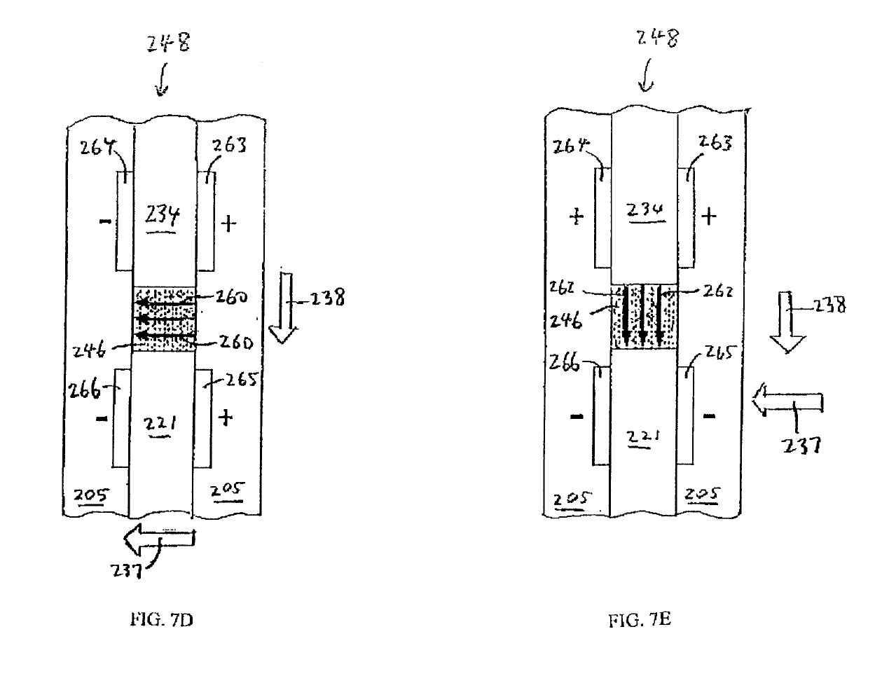

The present invention uses an electric field E vector (as used herein, vectors will generallly be designated with a “_” symbol), having a magnitude and a direction, to toggle the material 26 between the totally transmitting state and the totally reflecting state. Generally, if E exists in the material 26 then the refractive index n(E) in the material 26 is a function of E. Thus if optical waveguides 24 and 25 each have about the same refractive index n_{G}, then the material 26 can be placed in a totally transmitting state by changing E to E_{T} such that n(E_{T} ) is about equal to n_{G}. Similarly, the material 26 can be placed in a totally reflecting state by changing E to E_{R} such that n(E_{R} )<n_{G} sin θ_{I}. The electric field E is derived from a voltage distribution V that exists in the material 26; i.e., E=−∇V. The voltage distribution in the material 26 maybe generated by having a first electrode at a constant voltage V₁ and a second electrode at a constant voltage V₂ (where V₂≠V₁), such that the first and second electrodes are spaced apart and strategically placed outside the material 26. Thus the voltages on the first and second electrodes control E and thus n(E). The refractive index n(E) may be varied by changing the magnitude (E) E, the direction of E, or both. The magnitude of E may be varied by changing the differential voltage V₂−V₁. The direction of E may be varied by changing the location of the electrodes. Examples of placement of the first and second electrodes are discussed infra (see, e.g., FIGS. 7C, 7D, and 7E, and accompanying discussion). The material 26 may include an electrical-optical polymer, which offers several advantages as described supra.

The various devices of the present invention, including the optical switch of FIG. 4 described supra, utilize an electric field E vector in a material (e.g., electro-optical polymer) to vary or tune the refractive index n(E) in the material. The electric field E vector may be generated by, inter alia, strategically placing a pair of electrodes having differential voltage levels outside of material 26. The beam of light 28 entering the material may have a wavelength in a range of 1300 nanometers to 2000 nanometers. Note that the optical switch 20 of FIG. 4 advantageously achieves optical switching and related functionality without use of moving parts.

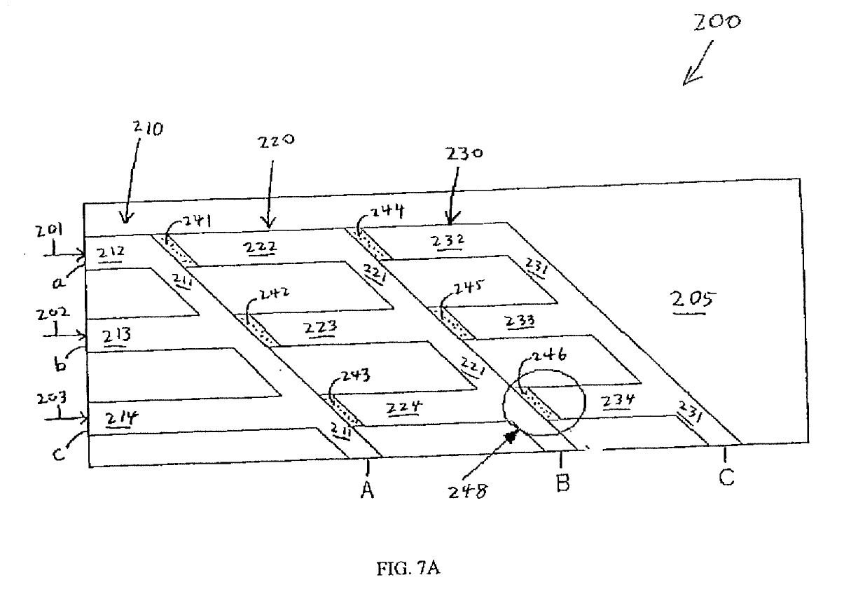

FIG. 5 depicts a 1×2 optical switch structure 30 comprising optical waveguides 32, 40, and 50, and materials 36 and 37, wherein said optical waveguides and said materials are disposed on a substrate 39, in accordance with embodiments of the present invention. Upper cladding and lower cladding (not shown) exists above and below each of the optical waveguides 32, 40, and 50 (see FIG. 3 for where the OPTICAL WAVEGUIDE is located relating to the UPPER CLADDING and LOWER CLADDING). The optical waveguides 32,40, and 50 each have about equal refractive indexes. The “1×2 ” refers to 1 input port and 2 output ports of the 1×2 optical switch 30.

The optical waveguide 32 has an input end 33 and output ends 34 and 35. The optical waveguide 40 has an input end 41 and an output end 42. The optical waveguide 50 has an input end 51 and an output end 52. An incoming light beam 54 enters the optical waveguide 32 at its input end 33 (which serves as an input port of the switch 30). The incoming light beam 54 may have a wavelength in a range of 1300 nanometers to 2000 nanometers. The material 36 includes an electro-optical polymer which offers several advantages as described supra, and is disposed between the output end 34 of the optical waveguide 32 and the input end 41 of the optical waveguide 40. A first pair of spaced electrodes (not shown) having a differential voltage ΔV₁ therebetween generates an electric field E₁ and consequent refractive index n(E₁ ) in the material 36, thereby enabling the optical waveguide 32, the material 36, and the optical waveguide 40 to collectively serve as an optical switch for transmitting (totally or partially) or reflecting (totally or partially) the light beam 54. Alternatively, the electric field E₁ in the material 36 may have a value that places material 36 in a totally reflecting state for totally reflecting the light beam 54. In addition, the electric field E₁ in the material 36 may have a value that places material 36 in a partially reflecting state for transmitting and reflecting the light beam 54.

The material 37 includes an electro-optical polymer which offers several advantages as described supra, and is disposed between the output end 35 of the optical waveguide 32 and the input end 51 of the optical waveguide 50. A second pair of spaced electrodes (not shown) having a differential voltage ΔV₂ therebetween generates an electric field E₂ and consequent refractive index n(E₂ ) in the material 37, thereby enabling the optical waveguide 32, the material 37, and the optical waveguide 50 to collectively serve as an optical switch for transmitting or reflecting the light beam 54. Alternatively, the electric field E₂ in the material 37 may have a value that places material 37 in a totally reflecting state for totally reflecting the light beam 54. In addition, the electric field E₂ in the material 37 may have a value that places material 37 in a partially reflecting state for transmitting and reflecting the light beam 54. Note that ΔV₁ and ΔV₂ may be controlled independently. Examples of placements that could be used for the first and second pair of electrodes are discussed infra (see, e.g., FIGS. 7C, 7D, and 7E, and accompanying discussion).

In accordance with the preceding possible states of the materials 36 and 37, the light beam 54 in the optical waveguide 32 may travel in several alternative paths. If the material 36 is in a totally transmitting state and the material 37 is in a totally reflecting state, then the light beam 54 will propagate only into the optical waveguide 40 and exit as light beam 55 at the end 42 of the optical waveguide 40 (which serves as a first output port of the switch 30). If the material 36 is in a totally reflecting state and the material 37 is in a totally transmitting state, then the light beam 54 will propagate only into the optical waveguide 50 and exit as light beam 56 at the end 52 of the optical waveguide 50 (which serves as a second output port of the switch 30). Under other states of the materials 36 and 37, the light beam 54 will split and propagate into both the optical waveguide 40 and the optical waveguide 50 such that exit beam 55 and exit beam 56 will emerge from the first output port and the second output port, respectively. Such other states of the materials 36 and 37 comprise all combinations of: the material 36 is in a totally transmitting or a partially reflecting state, and the material 37 is in a totally transmitting or a partially reflecting state. If the materials 36 and 37 are both in a totally reflecting state, then neither exit beam 55 nor exit beam 56 will emerge from the first output port and the second output port, respectively. Note that the 1×2 optical switch structure 30 of FIG. 5 advantageously achieves optical switching and related functionality without use of moving parts.

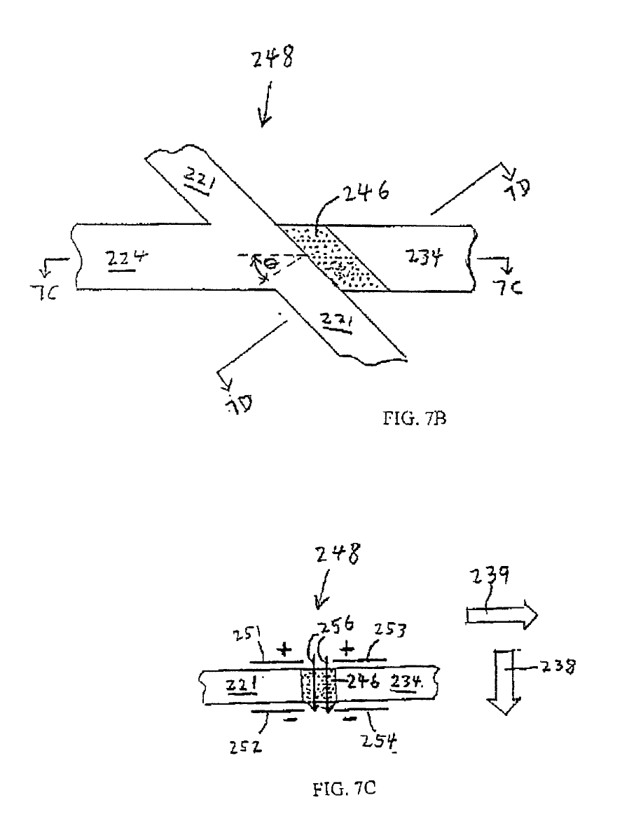

FIG. 6 depicts a waveguide-based planar cross switch structure 70, in accordance with embodiments of the present invention. The cross switch structure 70 comprises 4 switch elements (i.e., switch elements 121, 122, 123, and 124) and 3 crossguides (i.e., crossguides 90, 93, and 96), wherein each said switch element and each said crossguide is disposed on a substrate 71. The switch element 121 comprises optical waveguide 72, optical waveguide 73, and interface optical material 111 that includes an electro-optical polymer which offers several advantages as described supra, wherein the interface material 111 interfaces the optical waveguide 72 to the optical waveguide 73. An entrance “a” to the switch element 121 is a first input port of the cross switch structure 70, and an exit “A” from the switch element 121 is a first output port of the cross switch structure 70. The switch element 122 comprises optical waveguide 74, optical waveguide 75, optical waveguide 76, and interface materials 112 and 113 each including an electro-optical polymer which offers several advantages as described supra, wherein the interface material 112 interfaces the optical waveguide 74 to the optical waveguide 75, and wherein the interface material 113 interfaces the optical waveguide 75 to the optical waveguide 76. An entrance “b” to the switch element 122 is a second input port of the cross switch structure 70, and an exit “B” from the switch element 122 is a second output port of the cross switch structure 70. The switch element 123 comprises optical waveguide 77, optical waveguide 78, optical waveguide 79, and interface materials 114 and 115 each including an electro-optical polymer which offers several advantages as described supra, wherein the interface material 114 interfaces the optical waveguide 77 to the optical waveguide 78, and wherein the interface material 115 interfaces the optical waveguide 78 to the optical waveguide 79. An entrance “c” to the switch element 123 is a third input port of the cross switch structure 70, and an exit “C” from the switch element 123 is a third output port of the cross switch structure 70. The switch element 124 comprises optical waveguide 80, optical waveguide 81, and interface material 116 that includes an electro-optical polymer which offers several advantages as described supra, wherein the interface material 116 interfaces the optical waveguide 80 to the optical waveguide 81. An entrance “d” to the switch element 124 is a fourth input port of the cross switch structure 70, and an exit “D” from the switch element 124 is a fourth output port of the cross switch structure 70.

The switch elements 121 and 124 are each a “2W switch”, denoting 2 waveguides, because the switch elements 121 and 124 each comprise two waveguides with an interface material interfacing one of the two waveguides to the other of the two waveguides.

The switch elements 122 and 123 are each a “3W switch”, denoting 3 waveguides, because the switch elements 122 and 123 each comprise three waveguides with a first interface material interfacing a first waveguide to a second waveguide of the three waveguides, and with a second interface material interfacing the second waveguide to a third waveguide of the three waveguides.

The crossguide 90 comprises optical waveguides 91 and 92. The crossguide 90 “cross couples” the switch element 121 to the switch element 122. In other words, the optical waveguides 91 and 92 cross each other such that they each connect the switch element 121 to the switch element 122, with the interface material 111 positioned to perform switching between waveguides 91 and 73, and with the interface material 113 positioned to perform switching between waveguides 92 and 76 (e.g., interfacing materials 111, 113 are positioned between the waveguides 91 and 92 as they intersect a common switch 121 or 122). The crossguide 93 comprises optical waveguides 94 and 95. The crossguide 93 cross couples the switch element 122 to the switch element 123. In other words, the optical waveguides 94 and 95 cross each other such that they each connect the switch element 122 to the switch element 123, with the interface material 112 positioned to perform switching between waveguides 94 and 75, and with the interface material 114 positioned to perform switching between waveguides 95 and 78 (e.g., interfacing materials 112, 114 are positioned between the waveguides 94 and 95 as they intersect a common switch 122 or 123). The crossguide 96 comprises optical waveguides 97 and 98. The crossguide 96 is said to cross couple the switch element 123 to the switch element 124, which means that they cross each other such that the optical waveguides 97 and 98 each connect the switch element 123 to the switch element 124, with the interface material 115 positioned to perform switching between waveguides 97 and 79, and with the interface material 116 positioned to perform switching between waveguides 98 and 81 (e.g., interfacing materials 115, 116 are positioned between the waveguides 97 and 99 as they intersect a common switch 123 or 124).

Note that upper cladding and lower cladding (not shown) exists above and below each of the optical waveguides shown in FIG. 6 (i.e., optical waveguides 72-81, 91-92, 94-95, and 97-98). See FIG. 3 for where the OPTICAL WAVEGUIDE is located relating to the UPPER CLADDING and LOWER CLADDING). All optical waveguides shown in FIG. 6 have about equal refractive indexes.

The interface material in each switch element (i.e., each of interface materials 111-116) has a refractive index n(E) that depends on the magnitude and direction of an electric field vector E existing within said interface material. E depends on a voltage drop ΔV across said interface material, wherein ΔV is adapted to be set to a value that causes said interface material to be in a totally transmitting or totally reflecting state relative to a beam of light incident upon such interface material. ΔV is independently controlled for each such interface material. ΔV for each such interface material may be generated by use of a pair of spaced electrodes (not shown) having the differential voltage ΔV therebetween to generate the electric field E and consequent refractive index n(E) in the interface material. Examples of placements that could be used for said pair of electrodes are discussed infra (see, e.g., FIGS. 7C, 7D, and 7E, and accompanying discussion).

A beam of light 101, 102, 103, or 104 may enter input port a, b, c, or d, respectively. Each such beam of light 101, 102, 103, or 104 may have a wavelength in a range of 1300 nanometers to 2000 nanometers. Based on the preceding discussion, the beam of light 101, 102, 103, or 104 entering input port a, b, c, or d, respectively, may exit though exit port A, B, C, D in accordance with the truth table shown as Table 1.

TABLE 1
Truth table for the cross switch structure 70 of FIG. 6.

| | |
|---|---|
| Input | Output Port |

| Port | A | B | C | D |
|---|---|---|---|---|
| a | 1 | 1 | 0 | 0 |
| b | 1 | 1 | 1 | 1 |
| c | 1 | 1 | 1 | 1 |
| d | 0 | 0 | 1 | 1 |

In the truth table of Table 1, a “1” denotes a possible path for the beam of light 101, 102, 103, or 104, and a “0” denotes an impossible path for the beam of light 101, 102, 103, or 104. In Table 1, all input port→output port optical paths are possible except a→C, a→D, d→A, and d→B. Note that the crossguides 90, 93, and 96 facilitate “non-blocking” which is defined as the enabling of light that enters a given input port to exit at a given output port. “Blocking” is defined as an inability of light that enters a given input port to exit at a given output port. Blocking and non-blocking occurs pathwise. Thus a “1” in a cell of Table 1 denotes non-blocking for the optical path associated with the cell, while a “0” in a cell of Table 1 denotes blocking for the optical path associated with the cell. As examples in Table 1, there is non-blocking for the b→C path and blocking for the d→A path. A non-blocking fraction is defined as the ratio of the number “1” values to the total number of values (“0” or “1”). Thus Table 1 shows that the non-blocking fraction for the cross switch structure 70 of FIG. 6 is 0.75 (i.e., 12/16). “Total non-blocking” occurs if the non-blocking fraction is 1 (i.e., all input port→output port optical paths are possible).

The cross switch structure 70 of FIG. 6 includes 4 switch elements (i.e., switch elements 121, 122, 123, and 124) and 3 crossguides (i.e., crossguides 90, 93, and 96), as described supra, such that the outermost switch elements 121 and 124 are each 2W switch elements and the inner switch elements 122 and 123 are 3W switch elements.

The cross switch structure 70 of FIG. 6 may be reduced to 3 switch elements by:

eliminating the switch element 124, eliminating the crossguide 96, eliminating interface material 115, and joining the optical waveguide 78 to the optical waveguide 79 so that the optical waveguides 78 and 79 collectively constitute a single, continuous waveguide. The resulting cross switch structure includes the 3 switch elements 121, 122, and 123, and the 2 crossguides 90 and 93, such that the outermost switch elements 121 and 122 are each 2W switch elements and the inner switch element 122 is a 3W switch element. The resulting truth table is Table 1 with the “D” column and the “d” row eliminated, so that all input port output port optical paths are possible except a→C, and such that the non-blocking fraction is 0.89 (i.e., 8/9).

The cross switch structure 70 of FIG. 6 may be reduced to 2 switch elements by: eliminating the switch elements 123 and 124, eliminating the crossguides 93 and 96, eliminating interface material 112, and joining the optical waveguide 74 to the optical waveguide 75 so that the optical waveguides 74 and 75 collectively constitute a single, continuous waveguide. The resulting cross switch structure includes the 2 switch elements 121 and 122, and the crossguide 90, such that the outermost switch elements 121 and 123 are each 2W switch elements and there are no inner switch elements. The resulting truth table is Table 1 with the “C” column, the “D” column, the “c” row, and the “d” row eliminated, so that all input port→output port optical paths are possible and there is total non-blocking.

The preceding discussion shows that a waveguide-based planar cross switch structure, may generally comprise N switch elements (denoted as E₁, E₂, . . . , E_{N}) and N−1 crossguides (denotes as C₁, C₂, . . . , C_{N-1}), wherein N≧2. The crossguide C_{I} cross couples the switch element E_{I} to the switch element E_{I+1} for I=1, 2, . . . , and N−1. E₁ and E_{N} are each a 2W switch element. If N>2 then E₂, E₃, . . . , and E_{N-1} are each a 3W switch element. Each switch element has an entrance and an exit. Each interface material in each switch element includes an electro-optical polymer which offers several advantages as described supra. Note that the waveguide-based planar cross switch structure 70 of FIG. 6 advantageously achieves optical switching and related functionality without use of moving parts.

FIGS. 7A, 7B, 7C, 7D, and 7E (collectively “FIG. 7”) depict a view of a 3×3 comb switch structure 200, or portions thereof.

FIG. 7A depicts a top view of a 3×3 comb switch structure 200 (i.e., 3 input ports and 3 output ports), comprising a combguide 210, a combguide 220, and a combguide 230, all disposed on a substrate 205, in accordance with embodiments of the present invention. A “combguide” is a “comb waveguide” having a base waveguide and tooth waveguides, wherein each base waveguide is coupled to a number of tooth waveguides that is equal to the number of combguides present in the comb switch structure (e.g., 3 in the comb switch structure 200 illustrated in FIG. 7A). The combguide 210 comprises abase waveguide 211 and tooth waveguides 212, 213, and 214. The combguide 220 comprises a base waveguide 221 and tooth waveguides 222, 223, and 224. The combguide 230 comprises a base waveguide 231 and tooth waveguides 232, 233, and 234. Interface materials 241, 242, and 243 respectively couple the tooth waveguides 222, 223, and 224 of the combguide 220 to the base waveguide 211 of the combguide 210. Interface materials 244, 245, and 246 respectively couple the tooth waveguides 232, 233, and 234 of the combguide 230 to the base waveguide 221 of the combguide 220. The interface materials 241-246 each include an electro-optical polymer which offers several advantages as described supra. Entrances “a”, “b”, and “c” to the tooth waveguides 212, 213, and 214, respectively, are input ports of the cross switch structure 200. Exits “A”, “B”, and “C” from the base waveguides 211, 221, and 231, respectively, are outlet ports of the comb switch structure 200.

Upper cladding and lower cladding (not shown) respectively exist above and below each of the optical waveguides of FIG. 7 (i.e., optical waveguides 211-214, 221-224, and 231-234).

See FIG. 3 for where the OPTICAL WAVEGUIDE is located relating to the UPPER CLADDING and LOWER CLADDING. All optical waveguides shown in FIG. 7A have about equal refractive indexes.

The interface materials 241-246 each have a refractive index n(E) that depends on the magnitude and direction of an electric field vector E existing within each said interface material (see FIG. 7C-7E infra and accompanying discussion for various electric field orientations that may be utilized). E depends on a voltage drop ΔV across said interface material, wherein ΔV is adapted to be set to a value that causes said interface material to be in a totally transmitting or totally reflecting state relative to a beam of light entering the input port a, b, or c. The beam of light may have a wavelength in a range of 1300 nanometers to 2000 nanometers. ΔV is independently controlled for each such interface material. Thus, a beam of light 201, 202, or 203 entering input port a, b, or c, respectively, may exit though exit port A, B, or C an accordance with the truth table shown as Table 2.

TABLE 2
Truth table for the comb switch structure 200 of FIG. 7A.

| Input | Output Port | | |
|---|---|---|---|
| Port | A | B | C |
| a | 1 | 1 | 1 |
| b | 1 | 1 | 1 |
| c | 1 | 1 | 1 |

In the truth table of Table 2, a “1” denotes a possible path for the beam of light 201, 202, or 203, and a “0” denotes an impossible path for the beam of light 201, 302, or 203. In Table 2, all input port→output port optical paths are possible. Thus, the 3×3 comb switch structure 200 of FIG. 7A is totally non-blocking.

FIG. 7B depicts a magnified view of a portion 248 of the 3×3 comb switch structure of FIG. 7A, showing the material 246 interfaced between base waveguide 221 of the combguide 220 and the tooth waveguide 234 of the combguide 230. The angle θ defines the direction that a beam of light would make with the material 246, wherein the beam of light is directed from the tooth waveguide 224 toward the material 246.

FIG. 7C depicts a vertically oriented cross-section view of the portion 248 of FIG. 7B taken along line 7C-7C of FIG. 7B. Electrodes 251 and 252 are located “above” and “below” the material 246 with positive and negative relative polarity, respectively. The electrode 251 is located within or above the upper cladding, and the electrode 252 is located within or below the lower cladding. Similarly, electrodes 253 and 254 are respectively located “above” and “below” the material 246 with positive and negative polarity, respectively. The electrode 253 is located within or above the upper cladding, and the electrode 254 is located within or below the lower cladding. Thus electrodes 251 and 252, and electrodes 253 and 254, have voltage differentials which collectively generate an electric field (E) 256 pointing in the direction 238. Accordingly, the material 246 could be switched between a totally transmitting and a totally reflecting state by varying the magnitude of the voltage, which would vary the magnitude of the electric field (E) 256. For example, the totally transmitting state of the material 246 could be achieved by varying E such that n(E) of the material 246 matches the refractive index n_{G} of the base waveguide 221 and the tooth waveguide 234, and the totally reflecting state of the material 246 could be achieved by varying E such that n(E) of the material 246 such that n(E)<n_{G} sin θ, where θ is shown in FIG. 7B. If the material 246 is sufficiently thin in the direction 239, then either electrodes 251 and 252 alone, or electrodes 253 and 254 alone, may be sufficient to generate the electric field (E) 256 through the material 246, wherein said electric field (E) 256 would be of magnitudes that would effectuate switching between the aforementioned totally transmitting and totally reflecting states of the material optical 246.

FIG. 7D depicts a vertically oriented cross-section view of the portion 248 of FIG. 7B, taken along line 7D-7D of FIG. 7B. Electrodes 263 and 264 have positive and negative relative polarity, respectively, and are located at a same vertical level with respect to direction 238. Similarly, electrodes 265 and 266 have positive and negative relative polarity, respectively, and are located at a same vertical level with respect to direction 238. Electrodes 263 and 264 re located “above” the material 246, and are within or above the upper cladding. Electrodes 265 and 266 are located “below” the material 246, and are within or below the lower cladding. Thus, the electrodes 263 and 264, and electrodes 265 and 266, have voltage differentials which collectively generate an electric field (E) 260 pointing in the direction 237. Accordingly, the material 246 could be switched between a totally transmitting and a totally reflecting state by varying the magnitude of the voltage, which would vary the magnitude of the electric field (E) 260. For example, the totally transmitting state of the material 246 could be achieved by varying E such that n(E) of the material 246 matches the refractive index n of the base waveguide 221 and the tooth waveguide 234, and the totally reflecting state of the material 246 could be achieved by varying E such that n(E) of the material 246 such that n(E)<n_{G} sin θ, where θ is shown in FIG. 7B. If the material 246 is sufficiently thin in the direction 238, then either electrodes 263 and 264 alone, or electrodes 265 and 266 alone, may be sufficient to generate the electric field (E) 260 through the material 246, wherein said electric field (E) 260 would be of magnitudes that would effectuate switching between the aforementioned totally transmitting and totally reflecting states of the material 246.

FIG. 7E depicts FIG. 7D with a redistribution of polarity on the electrodes 263-266 such that electrodes 263 and 264 have positive relative polarity, and electrodes 265 and 266 have negative relative polarity. The electrodes 263 and 265, and electrodes 264 and 266, have voltage differentials which collectively generate an electric field (E) 262 pointing in the direction 238. Accordingly, the material 246 could be switched between a totally transmitting and a totally reflecting state by varying the magnitude of the voltage, which would vary the magnitude of the electric field (E) 262. For example, the totally transmitting state of the material 246 could be achieved by varying E such that n(E) of the material 246 matches the refractive index n_{G} of the base waveguide 221 and the tooth waveguide 234, and the totally reflecting state of the material 246 could be achieved by varying E such that n(E) of the material 246 such that n(E)<n_{G} sin θ, where θ is shown in FIG. 7B. If the material 246 is sufficiently thin in the direction 237, then either electrodes 263 and 265 alone, or electrodes 264 and 266 alone, may be sufficient to generate the electric field (E) 262 through the material 246, wherein said electric field (E) 262 would be of magnitudes that would effectuate switching between the aforementioned totally transmitting and a totally reflecting states of the material 246.

Another alternative for switching the material 246 between a totally transmitting state and a totally reflecting state is to utilize the polarities shown in FIG. 7D for the electrodes 263-266 to achieve the totally transmitting state of the material 246, and the polarities shown in FIG. 7E for the electrodes 263-266 to achieve the totally reflecting state of the material 246, or vice versa depending on the functional dependence of n(E) on E for the material 246.

Although FIGS. 7A-7E (and accompanying discussion) describes a 3×3 comb switch structure, the scope of the present invention generally includes a N×N comb switch structure, comprising N combguides (denoted as G₁, G₂, . . . , G_{N}), wherein N≧2. A base waveguide of combguide I is coupled to the tooth waveguides of combguide I+1 (for i=1, 2, . . . , N−1) by interface materials (containing electro-optical polymers) as described supra. Each interface material may be independently switched into a totally transmitting state or a totally reflecting state by selectively varying an electric field in each interface material.

Advantages of the comb switch structure 200 of FIGS. 7A-7E include: independent routing of signals (e.g., light beams 201-203), parallel routing of signals, total non-blocking, high speed (as fast as of the order of 10⁻⁹ second for electro-optical polymer), individually controlled switching of the materials 241-246, and low cost mass production Note that the 3×3 comb switch structure 200 of FIG. 7 advantageously achieves optical switching and related functionality without use of moving parts.

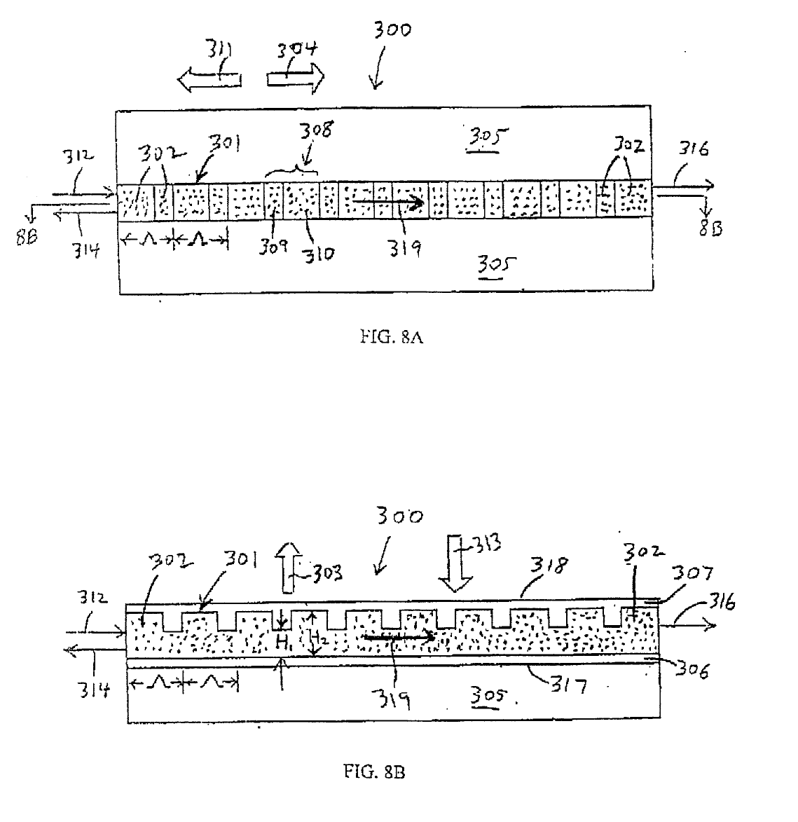

FIGS. 8A-8B, FIG. 9, and FIGS. 10A-10C, depict optical diffraction structures, in accordance with embodiments of the present invention.

FIG. 8A depicts a top view of an optical diffraction structure 300, in accordance with embodiments of the present invention, and FIG. 8B depicts a vertically oriented cross-section view taken along line 8B-8B of FIG. 8A. FIGS. 8A and 8B are collectively denoted as “FIG. 8”. The optical diffraction structure 300 comprises: an optical waveguide 301 on a substrate 305, a lower cladding 306 between the substrate 305 and the optical waveguide 301, an upper cladding 307 above the optical waveguide 301, an electrode 318 above or within the upper cladding 307, and an electrode 317 above the substrate 305 and below or within the lower cladding 306. The optical waveguide 301 comprises a material 302 that includes an electro-optical polymer which offers several advantages as described supra. The material 302 has a periodic geometric distribution, of period length Λ, in an axial direction 319 of the optical waveguide 301. A period 308 of the geometric distribution has the period length Λ and includes both a first subperiod 309 of height H₁ and a second subperiod 310 of height H₂. Generally, the period 308 may have any distribution that varies in height (i.e., in the direction 303) within the period 308.

The electrodes 318 and 317 have a differential voltage ΔV from electrode 318 to electrode 317, where ΔV generates an electric field E between the electrodes 318 and 317 such that E is aligned in the height direction of the optical waveguide 301 (i.e., in the direction 313 if ΔV>0, or in the direction 303 if ΔV<0). The electric field E (which is proportional to the gradient of the electrostatic potential or voltage) has a higher magnitude in the first subperiod 309 than in the second subperiod 310, since H₁<H₂. Thus E has the periodic distribution, of period length Λ, in the axial direction 319 of the optical waveguide 301. Inasmuch as the material 302 has a refractive index n(E) that depends on the magnitude and direction of E, it follows that n(E) likewise has the periodic distribution, of period length Λ, in the axial direction 319 of the optical waveguide 301. The period of the n(E) distribution coincides withe period 308 of the geometric distribution of the material 302.

If an incoming light beam 312 enters the optical waveguide 301, the beam 312 will experience partial reflection at interfaces of discontinuity between successive periods in the axial direction 319. Given the multiplicity of such interfaces of discontinuity, the beam 312 will experience multiple partial reflections, resulting in a net transmitted beam 316 and a net reflected beam 314. Due to the periodicity in the geometric distribution of the material 302 as well as the periodicity in the n(E) spatial distribution, in the axial direction 319, the multiple partial reflections will constructively interfere at a wavelength λ that satisfies the grating equation of λ=2Λn_{AVE}, wherein n_{AVE} is a spatial average of n(E) over the period of the n(E) spatial distribution. Thus if the light beam 312 includes multiple wavelengths, then the optical diffraction structure 300 will select the wavelength λ that satisfies the aforementioned grating equation. For the wavelength λ so selected, the reflected beam 314 is a diffracted beam. If such wavelength λ is being so selected and if it is desired to select a different wavelength λ′ that differs from λ by Δλ, then λ′ could be selected by changing the differential voltage ΔV in such a way that the refractive index n_{AVE} changes by Δn=Δλ/(2Λ). The light beam 312 may carry wavelengths in a range of 1300 nanometers to 2000 nanometers. Note that the optical diffraction structure 300 selects a wavelength λ of the diffracted beam 314 without use of moving parts.

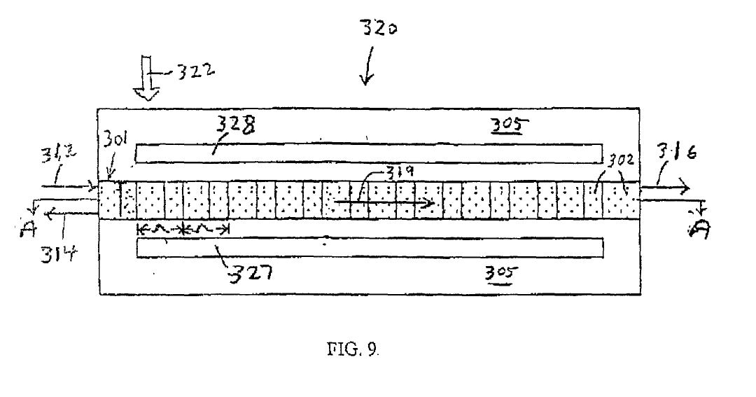

FIG. 9 depicts a top view of a optical diffraction structure 320, in accordance with embodiments of the present invention. The optical diffraction structure 320 of FIG. 9 differs from the optical diffraction structure 300 of FIG. 8 only in that the electrodes 317 and 318 in FIG. 8 are respectively replaced by electrodes 327 and 328 in FIG. 9. The electrodes 327 and 328 are displaced from optical waveguide 301 in the direction 322 as shown. Thus the optical diffraction structure 320 has a vertically oriented cross-section view taken along line A-A that is not shown herein, because said vertically oriented cross-section view taken along line A-A of FIG. 9 is the same as the vertically oriented cross-section view taken along line 8B-8B of FIG. 8A with the electrodes 317 and 318 omitted, which is shown in FIG. 8B.

In FIG. 9, the electrodes 327 and 328 are on opposite sides of the optical waveguide 301 with respect to the direction 322, and are therefore not seen in the vertical cross-sectional view along line A-A. A differential voltage ΔV from electrode 328 to electrode 327 generates an electric field E between the electrodes 328 and 327 in a direction that is parallel to the width direction of the optical waveguide 301 (i.e., in the direction that is parallel or antiparallel to the direction 322) and also in a direction that is normal to the vertical cross-section of FIG. 8B. Therefore, E is spatially uniform (i.e., constant) in the waveguide 301. Consequently, n(E) has a spatially uniform (i.e., constant) value n_{C} within the waveguide 301. The multiple partial reflections at geometric discontinuities constructively interfere at a wavelength λ that satisfies the grating equation of λ=2Λn_{C.} Thus if the light beam 312 includes multiple wavelengths, the optical diffraction structure 330 will select the wavelength λ that satisfies the aforementioned grating equation for the diffracted beam 314. If such wavelength λ is being so selected and if it is desired to select a different wavelength λ′ that differs from λ by Δλ, then λ′ could be selected by changing the differential voltage ΔV in such a way that the refractive index n_{C} changes by an amount Δn=Δλ/(2Λ) to a new constant value. Aside from the aforementioned distinctions relating to the difference in spatial position and orientation of the electrodes 328 and 329 of FIG. 9, as compared with the spatial position and orientation of the electrodes 317 and 318 of FIG. 8, all features and characteristics described supra for the optical diffraction structure 300 of FIG. 8 apply to the optical diffraction structure 320 of FIG. 9.

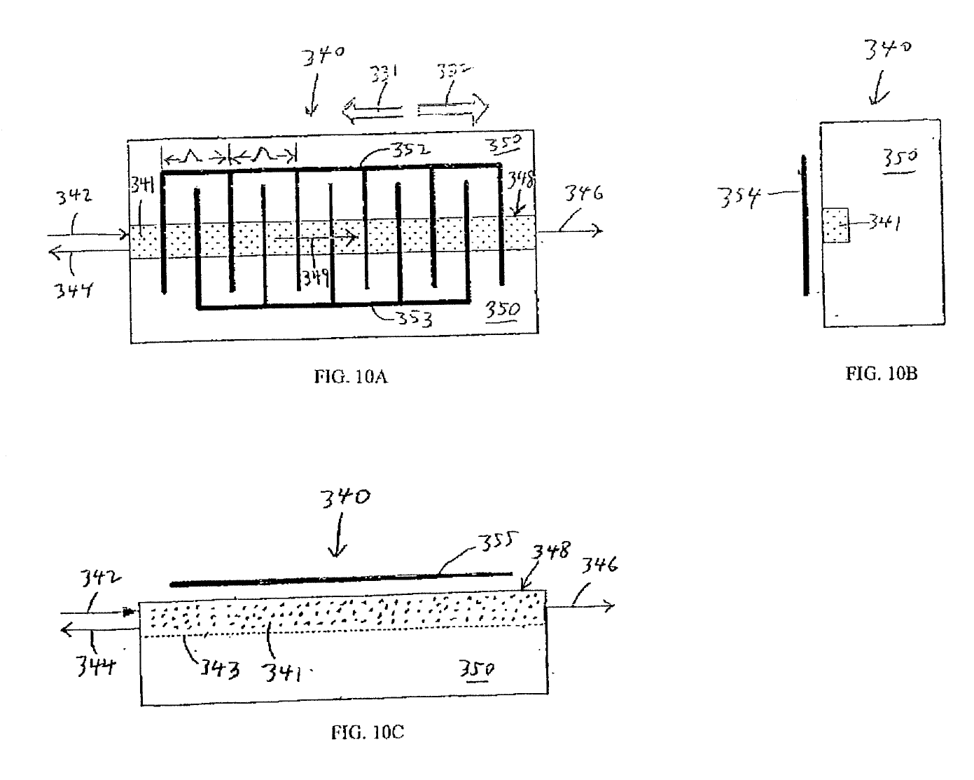

FIGS. 10A, 10B, and 10C (collectively “FIG. 10”) depict a top view, a side view, and a front view of an optical diffraction structure 340, in accordance with embodiments of the present invention. The optical diffraction structure 340 comprises: an optical waveguide 348 on a substrate 350, a lower cladding (not shown) between the substrate 350 and the optical waveguide 348, an upper cladding (not shown) above the optical waveguide 348, an electrode 352 above or within the upper cladding, and an electrode 353 also above or within the upper cladding. The lower cladding and upper cladding are located as shown for the lower cladding 306 and upper cladding 307, respectively, in the optical diffraction structure 300 of FIG. 8B. In FIG. 10B, the electrodes 354 represent the electrodes 352 and 353 of FIG. 10A projected in the side view of FIG. 10B as merged together. In FIG. 10C, the electrodes 355 represent the electrodes 352 and 353 of FIG. 10A projected in the front view of FIG. 10C as merged together. In FIG. 10C, a hidden boundary 343 exists between the optical waveguide 348 and the substrate 350, because the optical waveguide 348 is hidden in the front view. The optical waveguide 348 comprises a material 341 that includes an electro-optical polymer which offers several advantages as described supra. The material 341 is spatially uniform in an axial direction 349 of the optical waveguide 348.

The electrodes 352 and 353 have a differential voltage ΔV from electrode 352 to electrode 353, where ΔV generates an electric field E between the electrodes 352 and 353 in the axial direction 349 if ΔV>0, or opposite to the axial direction 349 if ΔV<0. Due to the geometry of the electrodes 352 and 353, ΔV alternates in sign (+ or −) in the axial direction 349, resulting in an electric field vector E that is periodic in the axial direction 349. E is considered to be oriented parallel to the axial direction 349 if E points in the axial direction 349 (i.e., in the direction 332) or if E points opposite to the axial direction 349 (i.e., in the direction 331). Accordingly, E has the periodic distribution, of period length Λ, in the axial direction 349 of the optical waveguide 301, as shown. Inasmuch as the material 341 has a refractive index n(E) that depends on the magnitude and direction of E, it follows that n(E) likewise has the periodic distribution (due to the direction change in E), of period length Λ, in the axial direction 349 of the optical waveguide 348. Note that the period of the n(E) distribution coincides withe period of the geometric distribution of the material 341.

If an incoming light beam 342 enters the optical waveguide 348, the beam 342 will experience partial reflection at interfaces of discontinuity between successive periods in the axial direction 349. Given the multiplicity of such interfaces of discontinuity, the beam 342 will experience multiple partial reflections, resulting in a net transmitted beam 346 and a net reflected beam 344. Due to the periodicity in the n(E) spatial distribution in the axial direction 349, the multiple partial reflections will constructively interfere at a wavelength λ that satisfies the grating equation of λ=2Λn_{AVE}, wherein n_{AVE} is a spatial average of n(E) over the period of the n(E) spatial distribution. Thus if the light beam 342 includes multiple wavelengths, the optical diffraction structure 340 will select the wavelength λ that satisfies the aforementioned grating equation. For the wavelength λ so selected, the reflected beam 344 is a diffracted beam. If such wavelength λ is being so selected and if it is desired to select a different wavelength λ′ that differs from λ by Δλ, then λ′ could be selected by changing the differential voltage ΔV in such a way that the average refractive index n_{AVE} changes by Δn=Δλ/(2Λ). The light beam 342 may carry wavelengths in a range of 1300 nanometers to 2000 nanometers. Note that the optical diffraction structure 340 selects a wavelength λ of the diffracted beam 344 without use of moving parts.

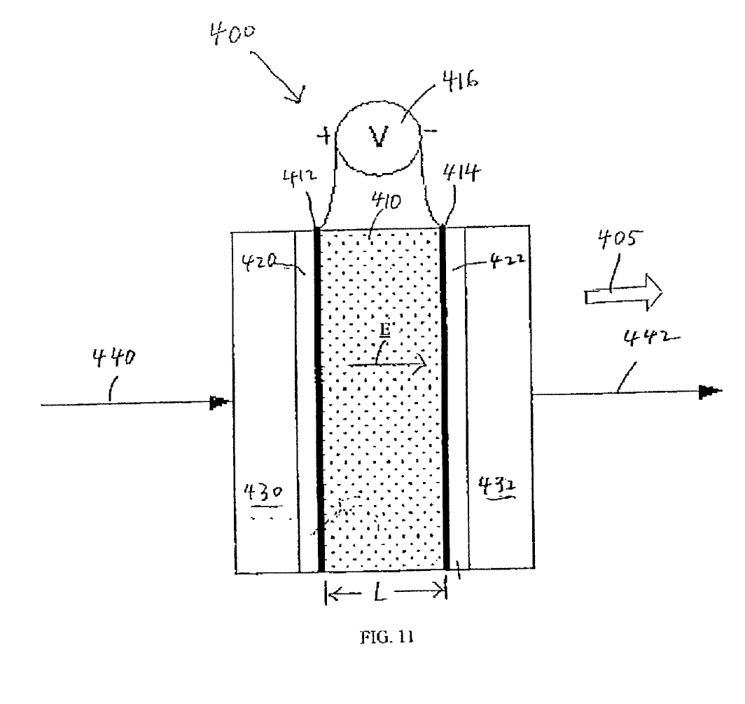

FIG. 11 depicts a view of an optical interference structure 400 based on a Fabry-Perot interference filter for wavelength selection, in accordance with embodiments of the present invention. The optical interference structure 400 comprises a material 410 of thickness L sandwiched between a mirror electrode 412 and a mirror electrode 414, a cladding 420 interposed between the mirror electrode 412 and a substrate 430, and a cladding 422 interposed between the mirror electrode 414 and a substrate 432 (it can also be arranged in such a way that electrodes 412 and 414 are transparent, and cladding 420 and 422 are high reflection dielectric mirrors). The material 410 includes an electro-optical polymer which offers several advantages as described supra. The mirror electrodes 412 and 414 each have a reflectance R and an absorptance A in relation to incident light.

A voltage source 416 generates a differential voltage ΔV between the mirror electrode 412 and the mirror electrode 414 which results in an approximately uniform electric field E in the material 410, where E is oriented in a direction 405. The material 410 has a refractive index n(E) that depends on E (i.e., the magnitude of E) and thus has a constant value n for a given value of E.

An incoming beam of light 440 propagates through the optical interference structure 400 such that a portion of the beam 440 is transmitted as a transmitted beam of light 442. The beam of light 440 includes multiple wavelengths A such as in a range of 1300 nanometers to 2000 nanometers. The transmitted beam of light 442 is determined by the following transmittance function T(λ):

T(λ)=[1−A/(1−R)]²/{1+[(2R^{½}/(1−R)) sin (2πLn)/λ)]^{2}} (1)

From Equation (1) for given values of A and R, T(λ) peaks if λ=λᵢ wherein λᵢ=2Ln/i, and wherein i is a positive integer. If λ=λᵢ and λ is changed to λᵢ+Δλ such that |Δλ/λ|<<1, and if R is close to 1, then T(λ) approaches 0 as A approaches 0. Thus T(λ) is sharply peaked about λᵢ if R is close to 1 and A is close 0. Under the preceding assumptions, the optical interference structure 400 can act as a wavelength filter to transmit only those wavelengths λᵢ=2Ln/i. Thus, a particular wavelength λ_{A} can be selectively transmitted by forcing n to have any of the values iλ_{A}/(2L), which can be accomplished by adjusting E (through adjustment of ΔV) in consideration of the dependence of n(E) on E.

Applications of the optical interference structure 400 include dense wavelength division multiplexing (“DWDM”) and spectral imaging. Additionally, the optical interference structure 400 implements the aforementioned wavelength filtering without use of moving parts.

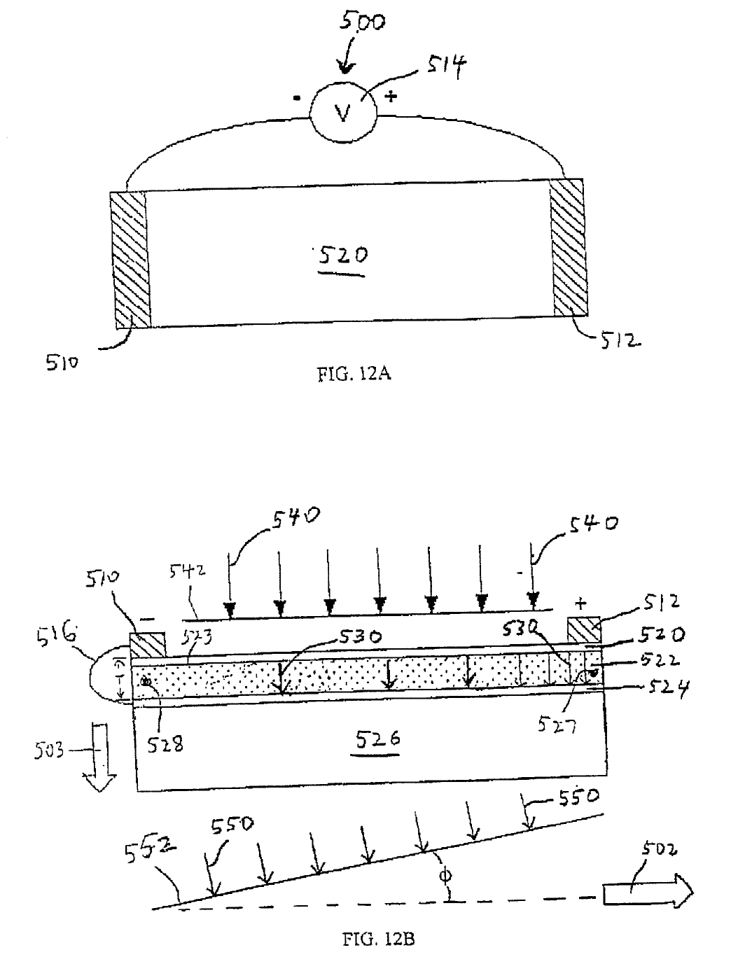

FIG. 12A depicts a top view of an optical prism structure 500, in accordance with embodiments of the present invention, and FIG. 12B depicts a front view of the optical prism structure 500 of FIG. 12A. FIGS. 12A and 12B are collectively denoted as “FIG. 12”. In the optical prism structure 500, an electrically resistive film 520 is on a material 522 that includes electro-optical polymer which offers several advantages as described supra. The material 522 is on a highly electrically conductive film 524, which is on a substrate 526. The material 522 has a thickness T as shown.

Metal electrodes 510 and 512 are mounted on the outwardly facing surface of the electrically resistive film 520. The metal electrode 510 is connected by a conductive coupler 516 (e.g., wire) to the conductive film 524. The conductive film 524 serves as an electrical ground and is at about the same electrical potential as the metal electrode 510. A voltage source 514 generates a differential voltage ΔV between the metal electrode 512 and the metal electrode 510, which results in an electric field E having field lines 530 such that E varies linearly from a maximum value of ΔV/T near the metal electrode 512 to a value of about zero near the metal electrode 510. The density of electric field 530 lines in direction 502 are indicative of the magnitude of E at various locations in the material 522.

The material 522 has a refractive index n(E) that depends on E and thus varies with E in the direction 502. Said variation of n(E) makes the material 522 act as a prism to an incoming plane wave of light 540. The plane wave 540, which has a wavelength in a range of 1300 nanometers to 2000 nanometers, has a wave front 542 that is parallel to the direction 502. The plane wave 540 strikes the external surface 523 of the material 522 and passes through the material 522. The wave velocity in the material 522 is inversely proportional to n(E) and is thus a function of E through the dependence of n(E) on E. Accordingly, the aforementioned variation of n(E) in the direction 502 is accompanied by a corresponding inverse variation in wave velocity in the material 522, which deflects (i.e., bends) the wave front 542 of the light 540. Said deflected light merges from the optical prism structure 500 as a deflected beam of light 550 having a wavefront 552.

FIG. 12B illustrates a case in which n(E) is smaller in the material 522 at a point 528 near the metal electrode 510 than is n(E) in the material 522 at a point 527 near the metal electrode 512. The lower n(E) at point 528 results in a higher wave velocity, so that in a given time interval, the light 540 travel a greater distance in the direction 503 at the point 528 than at the point 527. This causes a bending of the wavefront 540 such that the wavefront 552 of the deflected light 550 is rotated by an angle φ with respect to the direction 502. Note that the deflection angle φ is controlled by the applied differential voltage ΔV, since ΔV controls E, E controls n(E), and n(E) controls the wave velocity v(E). An advantage of the preceding method for deflecting the light beam 540 is that said deflecting can be accomplished by merely adjusting ΔV without using any moving parts.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. An optical switch, comprising:
a. a first optical waveguide having an input end and first and second output ends;
b. a second optical waveguide interconnected to said first optical waveguide and having an input end and an output end;
C. an electro-optical material disposed between said first output end of said first optical waveguide and said input end of said second optical waveguide, and having a refractive index that is selectively actuable between first and second states through application of an electric field generated therein; and
d. a voltage source for generating the electric field.

2. The optical switch of claim 1, wherein said refractive index is additionally actuable between first, second, and third states which are a totally transmitting state, a totally reflecting state, and a partially reflecting state, respectively.

3. The optical switch of claim 1, wherein said voltage source comprises first and second electrodes spaced apart from one another and positioned outside said electro-optical material.

4. The optical switch of claim 1, wherein said electro-optical material is a polymer.

5. A 1×2 optical switch structure, comprising:
a. a first optical waveguide having an input end, a first output end, and a second output end;
b. a second optical waveguide interconnected to said first optical waveguide and having an input end and an output end;
c. a third optical waveguide interconnected to said first optical waveguide and having an input end and an output end;
d. a first electro-optical material disposed between said first output end of said first optical waveguide and said input end of said second optical waveguide, and having a first refractive index that is selectively actuable between first and second states through application of a first electric field generated therein;
e. a first voltage source for generating the first electric field;
f. a second electro-optical material disposed between said second output of said first optical waveguide and said input end of said third optical waveguide, and having a second refractive index that is selectively actuable between first and second states through application of a second electric field generated therein; and
g. a second voltage source for generating the second electric field.

6. The optical switch of claim 5, wherein said first and second refractive indexes are additionally actuable between first, second, and third states which are a totally transmitting state, a totally reflecting state, and a partially reflecting state, respectively.

7. The optical switch of claim 5, wherein said first voltage source comprises first and second electrodes spaced apart from one another and positioned outside the first electro-optical material.

8. The optical switch of claim 5, wherein said second voltage source comprises first and second electrodes spaced apart from one another and positioned outside the second electro-optical material.

9. The optical switch of claim 5, wherein said electro-optical material is a polymer.

10. A waveguide-based planar cross switch structure, comprising:
a. N switch elements denoted as E₁, E₂, . . . , E_{N}, wherein N is at least 2, E₁ and E_{N} each comprising first and second waveguides interconnected to one another with a first switch mechanism positioned at the junction thereof, and wherein if N>2 then E₂, E₃, . . . , and E_{N-1} each comprise third and fourth waveguides interconnected to one another with a second switch mechanism positioned at the junction thereof, and a fifth waveguide interconnected to said fourth waveguide with a third switch mechanism positioned at the junction thereof; and
b. N−1 crossguides denoted as C₁, C₂, . . . , C_{N-1}, wherein C_{I} comprises sixth and seventh waveguides that intersect each other at intermediate positions therealong and optically couple E_{I} to E_{I+1} for I=1, 2, . . . , and N−1.

11. The cross switch structure of claim 10, wherein N=2.

12. The cross switch structure of claim 10, wherein N=4.

13. The cross switch structure of claim 10, wherein each of said first, second, and third switch mechanisms comprise:
a. an electro-optical material having a refractive index that is selectively actuable between first and second states through application of an electric filed generated therein; and
b. a voltage source electrically connected to said electro-optical material for generating an electric field therein.

14. The cross switch structure of claim 10, wherein said voltage source comprises first and second electrodes spaced apart and placed outside said electro-optical material.

15. A N×N comb switch structure, wherein N is at least 2, comprising:
a. N combguides each comprising a base waveguide and N tooth waveguides; and
b. a switching mechanism optically coupling said base waveguide of combguide I to each of said N tooth waveguides of combguide I+1, wherein I=1, 2, . . . , N−1.

16. The N×N switch structure of claim 15, wherein said switching mechanism comprises:
a. an electro-optical material having a refractive index that is selectively actuable between first and second states through application of an electric field generated therein;
b. a voltage source for generating the electric field in said electro-optical material.

17. The N×N comb switch structure of claim 16, wherein said voltage source comprises first and second electrodes spaced apart and placed outside said electro-optical material.

18. The N×N comb switch structure of claim 16, wherein said electro-optical material is a polymer.

19. The N×N comb switch structure of claim 15, wherein N=3.

20. An optical diffraction structure, comprising:
a. an optical waveguide extending in an axial direction;
b. an electro-optical material spatially distributed in successive periods along the axial length of said waveguide, and including a refractive index that is selectively actuable between first and second states through application of an electric field generated therein; and
c. a voltage source for generating said electric field.

21. The optical diffraction structure of claim 20, wherein said voltage source includes first and second electrodes spaced apart and positioned outside said electro-optical material.

22. The optical diffraction structure of claim 20, wherein said electro-optical material is geometrically distributed in a plane that is normal to the axial direction of said waveguide, wherein said geometric distribution has a periodic variation along the axial direction of said waveguide.

23. The optical diffraction structure of claim 20, wherein said electro-optical material is geometrically distributed in a plane that is normal to the axial direction of said waveguide, wherein said geometric distribution is spatially uniform along the axial direction of the waveguide.

24. An optical diffraction structure, comprising:
a. an optical waveguide having a width and longitudinally extending in an axial direction;
b. an electro-optical geometrically distributed within said waveguide in a plane that is normal to said axial direction, wherein the geometric distribution has a periodic variation along the axial direction of the waveguide, wherein said electro-optical material includes a refractive index that is selectively actuable between first and second states through generation of an electric field therein and that is aligned in the width direction of the waveguide; and
c. a voltage source for generating said electric field.

25. The optical diffraction structure of claim 24, wherein said voltage source comprises first and second electrodes spaced apart and positioned outside the material.

26. An optical interference structure, comprising:
a. a first mirror electrode having a reflectance R and an absorptance A;
b. a second mirror electrode having a reflectance R and an absorptance A;
C. a voltage source for generating an electric field between said first and second mirror electrodes; and
d. an electro-optical material positioned between said first mirror electrode and said second mirror electrode and having a predetermined thickness L and a refractive index that is selectively actuable between first and second states through generation of said electric field therein.

27. An optical prism structure, comprising:
a. a material composition having an outwardly facing surface and comprising an electro-optical material having an upwardly facing surface and a downwardly facing surface and a refractive index that is selectively actuable between first and second states through generation of an electric field therein; and
b. a voltage source for generating an electric field in said material composition, whereby receipt of a plane wave of light on said external surface will be transmitted through said material composition and the plane wave will be deflected by a finite angle such that the wavefront of the transmitted plane wave is non-parallel to said external surface.

28. The optical prism structure of claim 27, wherein said material composition further comprises:
a. an electrically resistive film mounted on said upwardly facing surface of said electro-optical material and forming said external surface; and
b. an electrically conductive film mounted on said downwardly facing surface of said electro-optical material.

29. The optical prism of claim 28, wherein said voltage source comprises at least one electrode mounted on said external surface, and an electrical coupling device extending between said at least one electrode and said electrically conductive film.
